(19) United States
(12) Patent Application Publication
(10) Pub. No.: US 2003/0113174 A1
(43) Pub. Date: Jun. 19, 2003

(54) Fiorello insert

(76) Inventor: Roy William Fiorello, Rockford, IL (US)

Correspondence Address: ROY FIORELLO JR., 1686 VALENCIA DR., ROCKFORD, IL, 61108, US

(21) Appl. No.: 09/835,268

(22) Filed: Aug. 7, 2001

(51) Int. Cl. B23B 27/14

(52) U.S. Cl. 407/113; 407/119

(57) ABSTRACT

The Fiorello Insert is made of a material similar to cratex rubber, and will be used to deburr machined parts while still in the machining cycle. It can also be used to open a bored hole a few tenths of a part or to take off a few tenths of the outside dimension of a part without changing it's contour or shape. It can also be used on reworked parts. The softness and slight abrasiveness of the insert is the key. It's not hard like the inserts used to cut, turn, or shape metal. It's more flexible like a piece of rubberized sandpaper being held in your hand that only follows the shape of the material being worked on. This insert will be made to the size and shapes of most standard inserts on the market now, thus eliminating costly tooling needed to be purchased to run this splendid insert. Its shape will be similar to the inserts being used now. Under certain conditions using the smaller Fiorello Inserts, a washer may be used for additional reinforcement when attaching the Fiorello Insert to the tool holder.

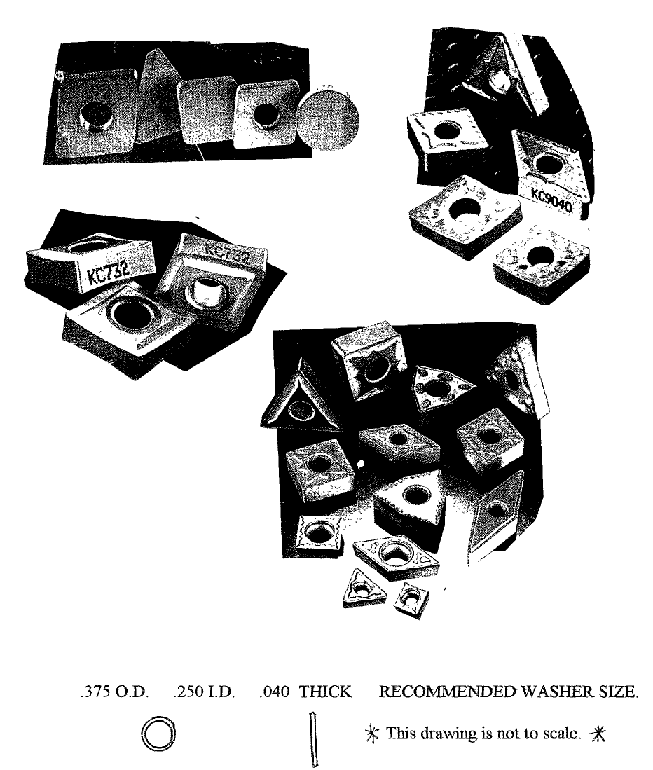

The Fiorello Insert can be manufactured into any shape such as these standard turning insert shapes shown below, and would fit into any major brand toolholder respectively.

A washer may be used for additional clamping support if needed on certain shapes.

Drawngs are not necessary drawn to scale.

1. I claim that this insert will be much safer for deburring parts, rather that running the risk of an injury such as dismemberment of a finger or hand.

2. I claim that this insert will deburr quicker and more consistent than holding a piece of sandpaper or craytex (or similar material) in your hand while the part is spinning on the machine.

3. I claim that the insert will get rid of most burrs that annoy machinists, thus eliminating the costly and time consuming chore of sending the parts to be deburred one by one.

4. I claim that this insert can be used on most standard tooling, therefore no special tooling will need to be purchased.
